(19) United States
(12) Patent Application Publication
(10) Pub. No.: US 2009/0158791 A1
(43) Pub. Date: Jun. 25, 2009

(54) TAMPER-RESISTANT HOSE BIB LOCK

(75) Inventors: Phillip A. Hudman, Centerville, UT (US); Jeremiah S. Morgan, Salt Lake City, UT (US)

Correspondence Address: AUSTIN RAPP & HARDMAN, 170 South Main Street, Suite 735, SALT LAKE CITY, UT, 84101, US

(73) Assignee: Orbit Irrigation Products, Inc., North Salt Lake City, UT (US)

(21) Appl. No.: 11/959,786

(22) Filed: Dec. 19, 2007

(51) Int. Cl. F16K 35/06; F16B 41/00

(52) U.S. Cl. 70/232

(57) ABSTRACT

A tamper-resistant hose bib lock is disclosed. The tamper-resistant hose bib lock may be utilized in connection with a hose bib having a threaded end and a narrow region proximate the threaded end. The hose bib lock includes a sealing cup having internal threads to engage the threaded end of the hose bib. The hose bib lock further includes a first mating jaw and a second mating jaw connected by an intermediate hinge. The hinge enables the mating jaws to be positioned in an open state and a closed state. The mating jaws, when in a closed state and positioned around the sealing cup secured to the threaded end of the hose bib, form an enclosure to surround and prevent access to the sealing cup.

### TECHNICAL FIELD

This invention relates generally to hose bibs and, in particular, to tamper-resistant hose bib locks that prevent unauthorized access to fluid dispensed by a hose bib.

### BACKGROUND OF THE INVENTION

Hose bibs are utilized for dispensing fluids in many different environments. For example, almost every residential home includes an external hose bib to dispense water. However, hose bibs are not limited to use with systems for dispensing water. Hose bibs may be utilized for dispensing fluids for chemical processing, such as in a chemistry laboratory or an industrial environment.

Regardless of the environment in which hose bibs are utilized, it is frequently desirable to limit access to the dispensed fluid. For example, in certain areas of the country, water has become expensive. Preventing unscrupulous neighbors or others from “stealing” water from a hose bib is becoming increasingly important. Furthermore, it is frequently desirable to limit access to a hose bib for innocuous reasons. A small child could, for example, carelessly turn on a hose bib adjacent to a home, potentially resulting in flooding and water damage to the home.

While hose bib locks have been developed to address some of these issues, conventional hose bib locks are poorly designed and can easily be circumvented. As a result, a tamper-resistant hose bib lock is desirable. Such a device is disclosed and claimed herein.

### SUMMARY OF THE INVENTION

A tamper-resistant hose bib lock is disclosed. The tamper-resistant hose bib lock may be utilized in connection with a hose bib having a threaded end and a narrow region proximate the threaded end.

The hose bib lock includes a sealing cup having internal threads to engage the threaded end of the hose bib. The sealing cup creates a fluid-tight seal between the sealing cup and the threaded end of the hose bib.

The hose bib lock further includes a first mating and a second mating jaw connected by an intermediate hinge. The hinge enables the mating jaws to be positioned in an open state and a closed state. The mating jaws, when in a closed state and positioned around a sealing cup secured to the threaded end of the hose bib, form an enclosure that surrounds and prevents access to the sealing cup.

Each mating jaw has a neck flange. When the mating jaws are in a closed state and surround a sealing cup secured to a hose bib, the neck flange of each of the mating jaws abuts or is sufficiently proximate the narrow region of the hose bib to prevent removal of the mating jaws from the hose bib.

In one embodiment, when the mating jaws are in a closed state, a seam between the two mating jaws is zigzag in shape. In such an embodiment, the first mating jaw has a first extension that mates with a first recess in the second mating jaw, and the second mating jaw has a second extension that mates with a second recess in the first mating jaw.

Each mating jaw may further include an end cap and a lock receptor extension secured to the end cap. Each lock receptor extension may be generally perpendicular to the end cap to which it is attached. In one embodiment, the lock receptor extensions of each of the mating jaws are aligned only when the mating jaws are in a closed position. This configuration more securely retains the mating jaws in a closed position, decreasing or eliminating the possibility that the jaws may be pried apart.

In one embodiment, lock receptor extensions are positioned on each mating jaw on proximate portions, which are situated generally opposite the hinge. In this embodiment, the lock receptor extensions, when the mating jaws are in a closed and locked state provide additional leverage, decreasing the possibility of prying the mating jaws apart.

In one embodiment, there is insufficient friction between the proximate surfaces of the sealing cup and the enclosure to cause the sealing cup to rotate by rotating the enclosure. This feature provides additional security, making it more difficult to remove the sealing cup and access the protected fluid.

The tamper resistant hose bib lock may be used in the following manner. A sealing cup having internal threads is secured to the threaded end of a hose bib to create a fluid-tight seal. The mating jaws are closed around the sealing cup. In the closed state, the mating jaws surround and prevent access to the sealing cup. The neck flange abuts or is proximate the narrow region of the hose bib to prevent removal of the mating jaws from the hose bib. A lock is secured through openings in each of the lock receptor extensions to secure the mating jaws in a closed state.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not, therefore, to be considered to be limiting of its scope, the invention will be described and explained with additional specificity and detail through the use of the accompanying drawings in which:

FIG. 1 is an exploded view of one embodiment of a tamper-resistant hose bib lock of the present invention shown with a hose bib;

FIG. 2 is a side, perspective view of the tamper-resistant hose bib lock of FIG. 1 with the sealing cup secured to a hose bib and mating jaws partially positioned around the sealing cup;

FIG. 3 is a perspective view of a tamper-resistant hose bib lock of FIG. 1 secured to a hose bib shown with a lock to maintain the hose bib lock in a closed state;

FIG. 4 is a partial cutaway view of the hose bib lock of FIG. 3 shown across line 4-4;

FIG. 5 is a bottom view of a tamper-resistant hose bib lock in a closed state and shown in phantom in an open state;

FIG. 6 is an exploded view of an alternative embodiment of a tamper-resistant hose bib lock of the present invention shown with a hose bib;

FIG. 7 is a side, perspective view of the tamper-resistant hose bib lock of FIG. 6 with the sealing cup secured to a hose bib and mating jaws partially positioned around the sealing cup; and

FIG. 8 is a perspective view of the tamper-resistant hose bib lock of FIG. 6 secured to a hose bib shown with a lock to maintain the hose bib lock in a closed state.

### DETAILED DESCRIPTION OF THE INVENTION

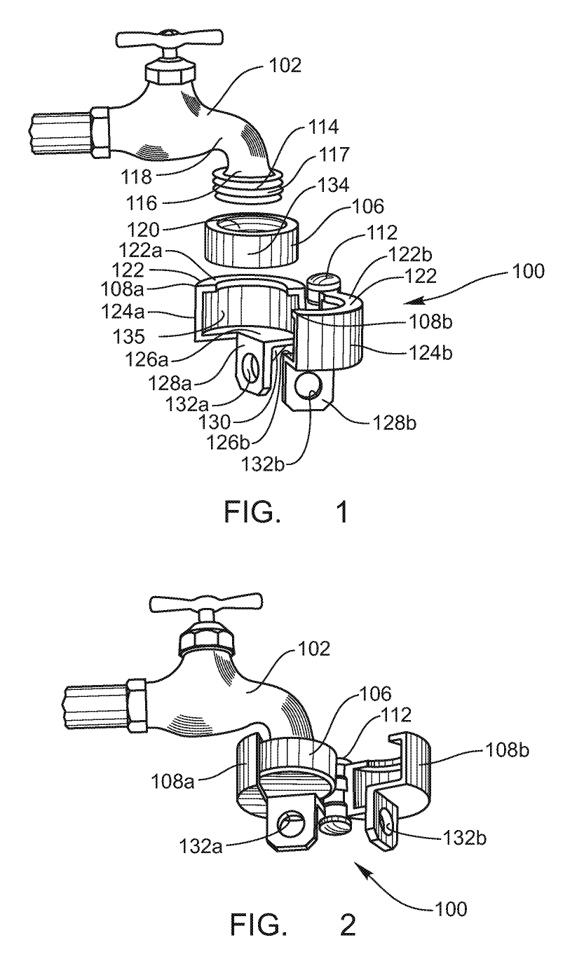

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the tamper-resistant hose bib lock of the present invention, as represented in FIGS. 1 through 5 is not intended to limit the scope of the invention, as claimed, but is merely representative of presently preferred embodiments of the invention.

FIG. 1 is an exploded view of a tamper-resistant hose bib lock 100 shown with a hose bib 102. The illustrated hose bib lock 100 includes a sealing cup 106, a first mating jaw 108a, and a second mating jaw 108b. An intermediate hinge 112 connects the first and second jaws 108a-b.

The hose bib 102 of FIG. 1 includes a threaded end 114 and a narrow region 116 adjacent to the threaded end 114. The threaded end 114 enables the attachment of hoses or, in this case, a sealing cup 106 to the hose bib 102. The narrow region 116 is narrower than adjacent regions of the hose bib 102 and, in particular, is more narrow than the threads 117. As will be explained in detail below, the narrow region 116 enables secure attachment of the tamper-resistant hose bib lock 100 to the hose bib 102.

The hose bib 102 may be configured in a number of different ways for use with the disclosed tamper-resistant hose bib lock 100. For example, the hose bib 102 may have a generally linear nozzle region rather having a curved nozzle region 118, as illustrated in the accompanying figures. The hose bib 102 is not part of the hose bib lock 100.

The sealing cup 106 is generally in the shape of a cup and includes internal threads 120 to engage the threaded end 114 of the hose bib 102. The purpose of the sealing cup 106 is to prevent fluid, such as water, from exiting the hose bib 102 when the sealing cup 106 is secured thereto. To achieve this purpose, the sealing cup 106 may be embodied in a number of different ways. For example, the sealing cup 106 may be made of a polymer-based material. Alternatively, the sealing cup 106 may be made of a metal material and a sealing material (not shown), such as a resilient sealing material. The dimensions and overall shape of the sealing cup 106 may be varied within the scope of this invention so long as the sealing function is achieved.

The hose bib lock 100 includes a first and a second mating jaw 108a-b, as indicated above. The mating jaws 108a-b are secured to each other utilizing a hinge 112. Thus, the mating jaws 108a-b may be positioned in an open and a closed state. In FIG. 1, the mating jaws 108a-b are shown in an open state.

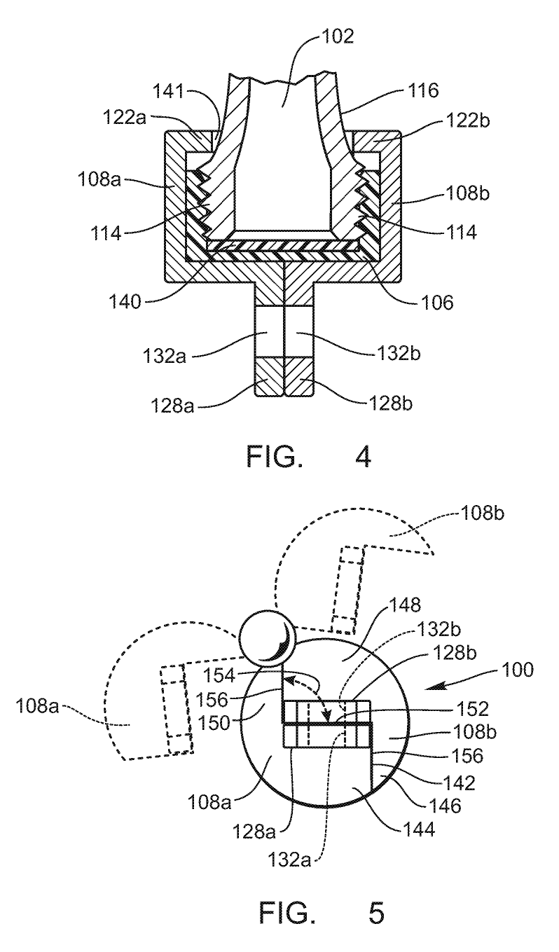

Each mating jaw 108a-b includes a neck flange 122a-b, an outer wall 124a-b, and an end cap 126a-b. When in a closed state, the neck flange 122a-b creates an opening (shown in FIG. 4) to receive the narrow region 116 of the hose bib 102. Working together, the neck flanges 122a-b abut or are sufficiently proximate the narrow region 116 of the hose bib 102 to prevent removal of the hose bib lock 100 from the hose bib 102 when the mating jaws 108a-b are in a closed state disposed about the hose bib 102. In a closed state, the outer wall 124a-b, neck flange 122a-b, and end cap 126a-b of each of the mating jaws 108a-b form an enclosure (shown in FIG. 3) that encompasses and prevents access, either directly or indirectly, to the sealing cup 106.

Referring to FIG. 1, a lock receptor extension 128a-b is attached to or integral with each end cap 126a-b. As illustrated, the lock receptor extensions 128a-b are generally at a perpendicular angle 130 relative to the end cap 126a-b to which it is attached. Alternative embodiments may be utilized within the scope of this invention, such as an embodiment in which the lock receptor extensions 128a-b are not perpendicular 130 to the end caps 126a-b and yet are generally parallel to each other. Alternatively, the lock receptor extensions 128a-b may be oriented in a non-parallel configuration.

Also, the shape of the lock receptor extensions 128a-b, as shown in FIG. 1, is generally rectangular. However, other shapes may be utilized such as square-shaped lock receptor extensions 128a-b, or lock receptor extensions utilizing a curved outer perimeter. Openings 132a-b in the lock receptor extensions 128a-b receive a lock (shown in FIG. 4) that secures the mating jaws 108a-b in a closed position.

In one embodiment, there is insufficient friction between the proximate surface 134 of the sealing cup 106 and the proximate surface 135 of the mating jaws 108a-b to cause the sealing cup 106 to rotate by rotating the mating jaws 108a-b. The lack of friction between the sealing cup 106 and the mating jaws 108a-b may be achieved in a number of different ways. For example, it may be achieved by manufacturing the mating jaws 108a-b and sealing cup 106 and to have proximate surfaces 134, 135 that are smooth. It may also be achieved in the alternative or together with the use of a smooth surface, by selecting materials from which the sealing cup 106 and the mating jaws 108a-b are made that will have relatively low friction coefficients. In addition, the neck flange 122 may extend and engage the hose bib 102 at the narrow region 116 before the proximate surfaces 134, 135 engage, thereby eliminating or mitigating any potential friction between the proximate surfaces 134, 135.

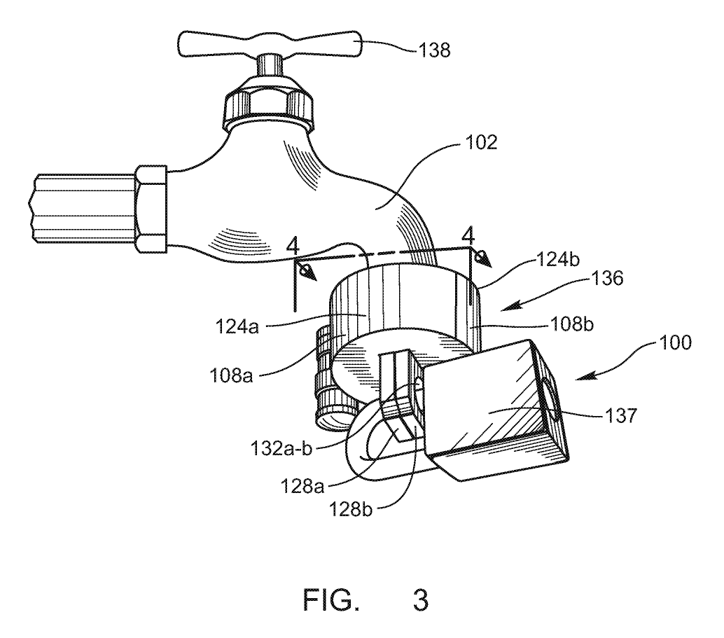

FIG. 2 illustrates the embodiment of the tamper-resistant hose bib lock 100 partially secured to a hose bib 102. As before, the illustrated hose bib 102 serves only as an example of a type of a hose bib 102 with which the disclosed invention may be utilized, and is not limiting of the type of hose bibs 102 with which the tamper-resistant hose bib lock 100 may be used.

As illustrated in FIG. 2, the sealing cup 106 has been secured to the threaded end 114 (shown in FIG. 1) of the hose bib 102. The first and second mating jaws 108a, 108b are in an open state. In particular, the first mating jaw 108a has been positioned adjacent to and around the sealing cup 106, and the second mating jaw 108b is disposed remote from the sealing cup 106, but ready to be pivoted into position about the hinge 112. Thus, this figure illustrates an intermediate step showing how an embodiment of the tamper-resistant hose bib lock 100 may be secured to a hose bib 102.

FIG. 3 shows an embodiment of the hose bib lock 100 in a closed and locked state. In this embodiment, the first and second jaws 108a, 108b are positioned in a closed state. In the closed state, the first and second mating jaws 108a, 108b form an enclosure 136 that surrounds and prevents access to the sealing cup 106 (not visible) and, as a result, prevents removal of the sealing cup 106 from the hose bib 102.

A locking device 137 has been positioned and secured through the openings 132a-b in the lock receptor extensions 128a-b of each of the mating jaws 108a, 108b. Those skilled in the art will recognize that many different types of locking devices 137 may be utilized with the tamper-resistant hose bib lock 100.

In the locked condition, the mating jaws 108a, 108b are secured in a closed state, preventing unauthorized access to the hose bib 102 and, in particular, preventing removal of the sealing cup 106. Because the sealing cup 106 creates a fluid-tight seal between the hose bib 102 and the sealing cup 106 itself, water will not flow from the hose bib 102 even if the adjustment knob 138 of the hose bib 102 is rotated to an open position. Thus, the tamper-resistant hose bib lock 100 prevents unauthorized use or waste of water or another fluid dispensed by the hose bib 102.

It may be noted here that the exterior shape of the enclosure 136 may be varied within the scope of this invention. For example, the outer wall 124a-b could have a generally square or rectangular or polygonal shape while the proximate surface 134 (shown in FIG. 1) forms generally a rounded shape to limit friction between the proximate surface 134 of the sealing cup 106 and the proximate surface 135 (again, shown in FIG. 1) of the enclosure 136.

FIG. 4 is a partial cutaway view of the tamper-resistant hose bib lock of FIG. 3 across the line 4-4. The narrow region 116 of the hose bib 102 is clearly illustrated in this figure. The mating jaws 108a, 108b are in a closed position. The sealing cup 106 is secured to the threaded end 114 of the hose bib 102.

As shown, the sealing cup 106 optionally includes a sealing material 140, such as a resilient material, that creates a fluid-tight seal between the sealing cup 106 and threaded end 114 of the hose bib 102. In an alternative embodiment, the sealing cup 106 itself may be made from a material to create a fluid-tight seal between the hose bib 102 and sealing cup 106.

The neck flange 122a-b of each of the mating jaws 108a, 108b abuts or is proximate to the narrow region 116 of the hose bib 102 and thus prevents removal of the hose bib lock 100 from the hose bib 102. In particular, the opening 141, optionally a circular opening 141, created by the neck flanges 122a-b is narrower than the adjacent portions of the hose bib 102, thereby preventing removal of the hose bib 102 without removal of the lock (shown in FIG. 3) securing the first and second mating jaws 108a, 108b together.

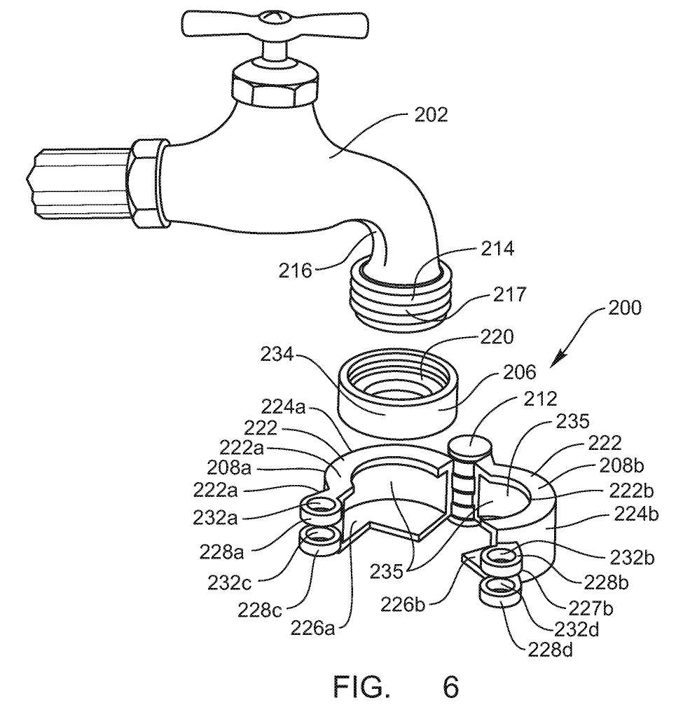

FIG. 5 is a bottom view of an embodiment of the hose bib lock 100 shown in a closed state. The hose bib lock 100 is also shown in phantom in an open state. For simplicity, a locking device 137 is not shown in this figure. As can be seen in this illustration, the lock receptor extensions 128a-b, and in particular the openings 132a-b in the lock receptor extensions 128a-b, are only aligned when the mating jaws 108a, 108b are in a closed position. When mating jaws 108a, 108b are in the open position (shown in phantom), the lock receptor extensions 128a-b are not aligned.

As illustrated, a seam 142 between the mating jaws 108a, 108b is generally zigzag in shape. The first mating jaw 108a includes a first extension 144 that mates with a first recess 146 of the second mating jaw 108b. Further, the second mating jaw 108b includes a second extension 148 that mates with a second recess 150 of the first mating jaw 108a. Of course, the mating jaws 108a, 108b may include any number of mating extensions 144, 148 and recesses 146, 150 within the scope of this invention, and the seam 142 may be curvilinear or zigzagged so long as the mating jaws 108a-b mate to prevent access to the sealing cup 106.

The central portion 152 of the seam 142, to which the lock receptor extensions 128a-b are adjacent, is generally oriented at perpendicular angle 154 relative to the remainder 156 of the seam 142. The perpendicular orientation of the lock receptor extensions 128a-b relative to the remainder 156 of the seam 142 improves the design, making it more difficult to pry the mating jaws 108a, 108b apart and access sealing cup 106 in an unauthorized manner.

It should be observed that in an alternative embodiment, the lock receptor extensions 128a-b may be oriented at a different angle, other than a perpendicular angle 154, relative to the remainder 156 of the seam 142. Also, the lock receptor extensions 128a-b could be positioned at different locations along the seam 142. There could be more than one set of lock receptor extensions 128a-b utilized within the scope of this invention. As an example, the lock receptor extensions 128a-b and/or zigzag seam 142 could be positioned on other sides of the mating jaws 108a, 108b, such as being positioned generally opposite the hinge 112 on the outer walls 128a-b (shown in FIG. 1).

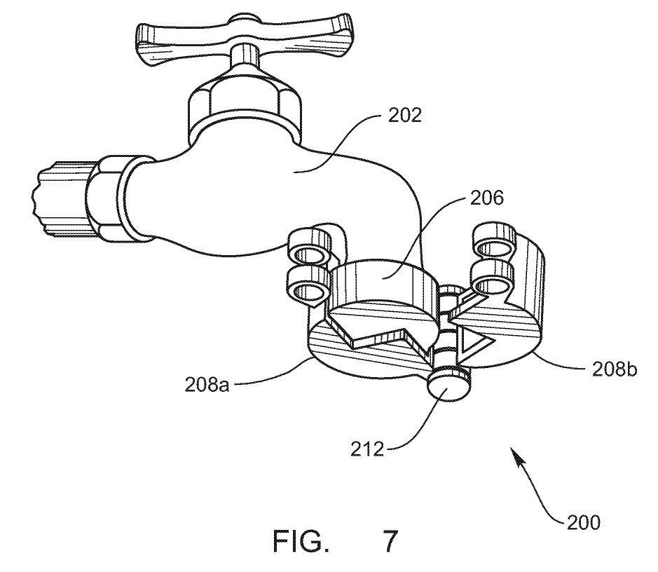

FIG. 6 is an exploded view of an alternative embodiment of a tamper-resistant hose bib lock 200 shown with a hose bib 202. As with the previously disclosed embodiment, the illustrated hose bib lock 200 includes a sealing cup 206, a first mating jaw 208a, and a second mating jaw 208b. An intermediate hinge 212 connects the first and second jaws 208a-b.

The hose bib 202 of FIG. 6 includes a threaded end 214 and a narrow region 216 adjacent to the threaded end 214. As before, the threaded end 214 enables the attachment of hoses or, in this case, a sealing cup 206 to the hose bib 202. The narrow region 216 is narrower than adjacent regions of the hose bib 202. In particular, the narrow region 216 is narrower than the threads 217 of the hose bib 202.

As explained in connection with the FIG. 1, the hose bib 202 may be configured in a number of different ways for use with the disclosed tamper-resistant hose bib lock 200. The hose bib 202 is not part of the hose bib lock 200.

The sealing cup 206 is generally in the shape of a cup and includes internal threads 220 to engage the threaded end 214 of the hose bib 202. The sealing cup 206 may be embodied in a number of different ways so long as the sealing function is achieved, as discussed in connection with FIG. 1. The sealing cup 206 may include a sealing material 140 (shown in FIG. 4).

The hose bib lock 200 includes a first and a second mating jaw 208a-b. The mating jaws 208a-b are secured to each other utilizing a hinge 212. Thus, the mating jaws 208a-b may be positioned in an open and a closed state. In FIG. 6, the mating jaws 208a-b are shown in an open state.

Each mating jaw 208a-b includes a neck flange 222a-b, an outer wall 224a-b, and an end cap 226a-b. When in a closed state, the neck flange 222a-b creates an opening (shown in FIG. 4) to receive the narrow region 216 of the hose bib 202. Working together, the neck flanges 222a-b abut or are sufficiently proximate the narrow region 216 of the hose bib 202 to prevent removal of the hose bib lock 200 from the hose bib 202 when the mating jaws 208a-b are in a closed state disposed about the hose bib 202. In a closed state, the outer wall 224a-b, neck flange 222a-b, and end cap 226a-b of each of the mating jaws 208a-b form an enclosure (shown in FIG. 8) that encompasses and prevents access, either directly or indirectly, to the sealing cup 206.

The embodiment shown in FIG. 6 differs from the embodiment shown in FIGS. 1-5 generally with respect to the lock receptor extensions 228a-d. In the embodiment of FIG. 6, the lock receptor extensions 228a-d protrude from the outer walls 224a-b, rather than the end caps 226a-b. Lock receptor extensions 228a-d are positioned on distal portions 227a-b of the outer walls 224a-b, which are positioned on the mating jaws 208 a-b generally opposite the hinge 212. Furthermore, each mating jaw 208a-b includes a pair of lock receptor extensions 228a-d, rather than a single lock receptor extension. Of course, a single or more than two lock receptor extensions 228a-d may be used on each mating jaw 208a-b within the scope of this invention. Openings 232a-d in the lock receptor extensions 228a-d receive a locking device that secures the mating jaws 208a-b in a closed position.

Referring to FIG. 6, lock receptor extensions 228a-d are attached to or integral with each outer wall 224a-b. The lock receptor extensions 228a-d protrude in a direction generally away from the hinge 212. Of course, the lock receptor extensions 228a-d may be positioned at other angles in a parallel or nonparallel fashion and may be formed in various shapes to enable receipt of a locking device (shown in FIG. 8) to secure the first and second mating jaws 208a-b together.

In one embodiment, there is insufficient friction between the proximate surface 234 of the sealing cup 206 and the proximate surface 235 of the mating jaws 208a-b to cause the sealing cup 206 to rotate by rotating the mating jaws 208a-b. As noted in connection with FIG. 1, the lack of friction between the sealing cup 206 and the mating jaws 208a-b may be achieved in a number of different ways.

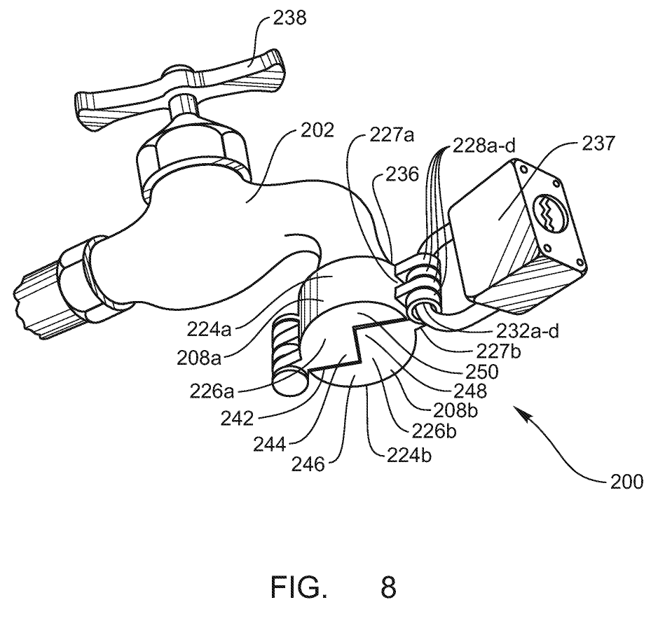

FIG. 7 illustrates the embodiment of the tamper-resistant hose bib lock 200 shown in FIG. 6 partially secured to a hose bib 202. As before, the illustrated hose bib 202 serves only as an example of a type of a hose bib 202 with which the disclosed invention may be utilized.

As illustrated in FIG. 7, the sealing cup 206 has been secured to the threaded end 214 (shown in FIG. 6) of the hose bib 202. The first and second mating jaws 208a, 208b are in an open state. In particular, the first mating jaw 208a has been positioned adjacent to and around the sealing cup 206, and the second mating jaw 208b is disposed remote from the sealing cup 206, but ready to be pivoted into position about the hinge 212. Thus, this figure illustrates an intermediate step showing how an embodiment of the tamper-resistant hose bib lock 200 may be secured to a hose bib 202.

FIG. 8 shows an embodiment of the hose bib lock 200 of FIG. 6 in a closed and locked state. In this embodiment, the first and second jaws 208a, 208b are positioned in a closed state. In the closed state, the first and second mating jaws 208a, 208b form an enclosure 236 that surrounds and prevents access to the sealing cup 206 (shown in FIG. 6) and, as a result, prevents removal of the sealing cup 206 from the hose bib 202.

A locking device 237 has been positioned and secured through the openings 232a-d in the lock receptor extensions 228a-d of each of the mating jaws 208a, 208b. Those skilled in the art will recognize that many different types of locking devices 237 may be utilized with the tamper-resistant hose bib lock 200.

In the locked condition, the mating jaws 208a, 208b are secured in a closed state, preventing unauthorized access to the hose bib 202 and, in particular, preventing removal of the sealing cup 206. Because the sealing cup 206 creates a fluid-tight seal between the hose bib 202 and the sealing cup 206 itself, water will not flow from the hose bib 202 even if the adjustment knob 238 of the hose bib 202 is rotated to an open position. Thus, the tamper-resistant hose bib lock 200 prevents unauthorized use or waste of water or another fluid dispensed by the hose bib 202. As explained above in connection with FIG. 3, the exterior shape of the enclosure 236 may be varied within the scope of this invention.

Further, the embodiment shown in FIG. 8 includes a zigzag shaped seam 242 between the end caps 226a-b, having a first extension 244 that mates with a first recess 246 with a second extension 248 that mates a second recess 250. However, a straight seam could also be utilized between the end caps 226a-b or a seam involving multiple zigzag directional changes, or multiple mating extensions and recesses.

Positioning of the lock receptor extensions 228a-b of the embodiment shown in FIG. 8 on the distal portions 227a-b of the outer wall 224a-b provides additional leverage to prevent separation of the mating jaws 208a-b. Positioning the lock receptor extensions in this manner further decreases the likelihood that the mating jaws 208a-b may be pried apart to access the sealing cup 206 or remove the hose bib lock 200. As shown, the lock receptor extensions 228a-d are made in an interdigitated fashion when the mating jaws 208a-b are positioned in a closed state. Of course, in alternative embodiments, the lock receptor extensions 228a-d do not interact in an interdigitated fashion.

With reference to FIGS. 1-8, the tamper resistant hose bib lock 100, 200 may be used in the following manner. A sealing cup 106, 206 having internal threads 120, 220 is secured to the threaded end 114, 214 of a hose bib 102, 202 to create a fluid-tight seal. The first and second mating jaws 108a-b, 208a-b are opened to receive the sealing cup 106, 206, which is now secured to the hose bib 102, 202. The mating jaws 108a-b, 208a-b are closed around the sealing cup 106, 206. In the closed state, the mating jaws 108a-b, 208a-b surround and prevent access to the sealing cup 106, 206. The neck flange 122a-b, 222a-b abuts or is proximate the narrow region 116, 216 of the hose bib 102, 202 to prevent removal of the mating jaws 108a-b, 208a-b from the hose bib 102. When the lock receptor extensions 128a-b, 228a-b, and the mating jaws 108a-b, 208a-b are in a closed state, they are aligned. A locking device 137, 237 is secured through the openings 132a-b, 232a-b in each of the lock receptor extensions 128a-b, 228a-b to secure the mating jaws 108a-b, 208a-b in a closed state.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A tamper-resistant hose bib lock for use on a hose bib having a threaded end, comprising:
a sealing cup having internal threads to engage the threaded end of the hose bib;
a first mating jaw with a first end cap and a second mating jaw with a second end cap; and
a hinge connecting the mating jaws that enables the mating jaws to be positioned in an open state and a closed state, the mating jaws, when in a closed state and positioned around the sealing cup secured to the threaded end of the hose bib, forming an enclosure to surround and prevent access to the sealing cup, wherein when the jaws are in the closed position, the first end cap and the second end cap cooperate to shield the sealing cup from access.

2. The tamper-resistant hose bib lock of claim 1, the hose bib having a narrow region proximate the threaded end, wherein each mating jaw has a neck flange, the neck flange of each of the mating jaws being sufficiently proximate or abutting the narrow region of the hose bib to prevent removal of the mating jaws from the hose bib when the mating jaws are in a closed state.

3. The tamper-resistant hose bib lock of claim 1, wherein the first mating jaw has a first extension that mates with a first recess in the second mating jaw, and the second mating jaw has a second extension that mates with a second recess in the first mating jaw when the mating jaws are in a closed state.

4. The tamper-resistant hose bib lock of claim 3, wherein a seam between the two mating jaws is zigzag in shape when the mating jaws are in a closed state.

5. The tamper-resistant hose bib lock of claim 1, wherein the sealing cup comprises sealing material to create a fluid-tight seal between the sealing cup and the threaded end of the hose bib.

6. The tamper-resistant hose bib lock of claim 1, further comprising lock receptor extensions positioned on each mating jaw generally opposite the hinge.

7. (canceled)

8. The tamper-resistant hose bib lock of claim 1, wherein each mating jaw includes a lock receptor extension on its end cap.

9. The tamper-resistant hose bib lock of claim 8, wherein each lock receptor extension is generally perpendicular to the end cap on which it is situated.

10. The tamper-resistant hose bib lock of claim 8, further comprising openings in each of the lock receptor extensions.

11. The tamper-resistant hose bib lock of claim 10, wherein the openings of the lock receptor extensions are aligned when the mating jaws are in a closed state.

12. The tamper-resistant hose bib lock of claim 2, wherein the neck flanges form a generally circular opening to receive the narrow region of the hose bib when the mating jaws are in a closed state.

13. The tamper-resistant hose bib lock of claim 1, wherein there is insufficient friction between proximate surfaces of the sealing cup and the mating jaws to cause the sealing cup to rotate by rotating the mating jaws.

14. A tamper-resistant hose bib lock for use on a hose bib having a threaded end, comprising:
a sealing cup having internal threads to engage the threaded end of the hose bib;
a first mating jaw and a second mating jaw, each mating jaw having a neck flange, an outer wall, and an end cap; and
a hinge connecting the mating jaws that enables the mating jaws to be positioned in an open state and a closed state, the mating jaws, when in a closed state and positioned around the sealing cup secured to the threaded end of the hose bib, forming an enclosure to surround and prevent access to the sealing cup, wherein when the jaws are in the closed position, the end cap of the first mating jaw and the end cap of the second mating jaw cooperate to shield sealing up from access.

15. The tamper-resistant hose bib lock of claim 14, the hose bib having a narrow region proximate the threaded end, wherein the neck flange of each of the mating jaws abutting or being sufficiently proximate the narrow region of the hose bib to prevent removal of the mating jaws from the hose bib when the mating jaws are in a closed state.

16. The tamper-resistant hose bib lock of claim 15, wherein the first mating jaw has a first extension that mates with a first recess in the second mating jaw, and the second mating jaw has a second extension that mates with a second recess in the first mating jaw when the mating jaws are in a closed state.

17. The tamper-resistant hose bib lock of claim 16, wherein a seam between the two mating jaws is zigzag in shape when the mating jaws are in a closed state.

18. The tamper-resistant hose bib lock of claim 14, wherein each mating jaw includes a lock receptor extension on its end cap.

19. The tamper-resistant hose bib lock of claim 18, wherein the lock receptor extensions are aligned when the mating jaws are in a closed state.

20. The method of preventing unauthorized access to a hose bib having a threaded end and a narrow region proximate the threaded end, comprising:
securing a sealing cup having internal threads to the threaded end of the hose bib;
opening a first and a second mating jaw to encompass the sealing cup secured to the hose bib, each mating jaw to encompass the sealing cup secured to the hose bib, each mating jaw having an end cap;
closing the mating jaws around a sealing cup to surround and prevent access to the sealing cup, each mating jaw having a neck flange and a lock receptor extension, the mating jaws being connected by a hinge, the neck flange of each of the mating jaws abutting or being sufficiently proximate the narrowed region of the hose bib to prevent removal of the mating jaws from the hose bib when the mating jaws are in a closed state, the lock receptor extensions being aligned when the mating jaws are in a closed state; and
securing a lock through the lock receptor extensions of each of the mating jaws to secure the mating jaws in a closed state, wherein when the jaws are in the closed position, the end cap of the first mating jaw and the end cap of the second mating jaw cooperate to sheild the sealing cup from access.
